(19) United States
(12) Patent Application Publication
(10) Pub. No.: US 2008/0186378 A1
(43) Pub. Date: Aug. 7, 2008

(54) METHOD AND APPARATUS FOR GUIDING TOWARDS TARGETS DURING MOTION

(76) Inventors: FEIMO SHEN, Grass Valley, CA (US); Dinesh Kumar, Grass Valley, CA (US); Jasjit S. Suri, Roseville, CA (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/938,888

(22) Filed: Nov. 13, 2007

Related U.S. Application Data
(60) Provisional application No. 60/888,429, filed on Feb. 6, 2007.

(51) Int. Cl. H04N 7/18

(52) U.S. Cl. 348/65; 348/E07.085

(57) ABSTRACT

A method and apparatus are disclosed for three-dimensional (3D) imaging and continuously updating organ shape and internal points for guiding targets during motion. It is suitable for image-guided surgery or operations as the speed of this guidance is achieved in real-time.

### CROSS-REFERENCE

This application claims the benefit of U.S. Provisional Application No. 60/888,429, entitled, “A METHOD AND APPARATUS FOR GUIDING TOWARDS TARGETS DURING MOTION,” having a filing date of Feb. 6, 2007, the entire contents of which is incorporated herein by reference.

### FIELD

The present invention relates to medical imaging arts. One particular application is 3D image guided surgery. Generally, the invention relates to a deformable object undergoing non-rigid motion and analysis on of the deformation for tracking intra-organ translocations.

### BACKGROUND

Image guided surgery is prevalent in modern operating rooms. The precision and accuracy of a surgical procedure for operating on specific targets located inside an organ or other body area depend on the knowledge of the exact locations of the targets. During a surgical procedure, a targeted organ tends to change shape and move due to external physical disturbances, discomfort introduced by the procedure, or intrinsic peristalsis. Because of the viscoelastic nature of biological tissue and many attachments and structural support it receives, the shape transformation tends to be non-Euclidean. That is, the deformation of the organ is non-rigid (i.e., not limited to rotation and translation).

While it is relatively uncomplicated to analyze images of objects with rigid motion, during which the surface shapes of the objects are kept constant, accounting for object deformation, or non-rigid motion, is considerably more difficult. Further, the need to account for such non-rigid motion usually rises when soft tissue such as human or animal organs being examined, imaged, or manipulated in vivo during a clinical or surgical operation, and the nature of the operation requires the image and guidance feedback to be in real-time.

Presently, many imaging modalities exist for in vivo imaging, for example, magnetic resonance imaging (MRI), X-ray computed tomography (CT), positron emission tomography (PET), and ultrasound. A prevalent imaging modality for real-time operation is ultrasound due to its low-cost of purchase, maintenance, and vast availability.

### SUMMARY

The present invention involves real-time corrective actions prompted by a computerized system during surgery or operation on people or animals. As an instrument approaches or touches the organ or region of operation, its position and shape usually change. Therefore, a new method of accurately finding these changes and automatically change the procedural tactics in real-time is provided.

As described above, a problem in this field is the translocation of the targeted areas caused by deformation and movement of the organ. The targets must be refreshed based on the newly acquired current state of volume position. It is therefore an objective of the current invention to trace the shifts of the targets based on a current imaged position to renew target coordinates.

It is an objective of this invention to introduce a method and an apparatus that, in a substantially continuous manner, finds and renews the position and shape change of the volume of interest as well as targets of interest within the volume, and display a refreshed model on screen with guidance (an animation) for the entire duration of the procedure. It will be noted that aspects of the invention may be implemented in processing systems that are integrated into medical imaging devices/systems and/or be implemented into stand-alone processing systems that interface with medical imaging devices/systems. Further, such aspects may be implemented in hardware and/or software.

It is also an objective of this invention to know exactly the locations of both the target intersecting tool and the volume of interest at all times by a unified, canonical coordinate system.

It is another objective of this invention to incorporate planning of the targets via pre-operatively computed model such as a probability atlas of the event of interest, or imaging techniques of locating the desired targets.

According to one aspect, a system and method (i.e, utility) is provided for use in updating previously identified target locations for a current 3-D image/volume of an internal object of interest. In this regard, previously identified target locations as located in a previous 3-D image of the internal object of interest may be applied to a current 3-D image while accounting for changes in the shape of the internal object of interest that may occur between obtaining the images. In this regard, the utility includes obtaining a first 3-D image at a first-time. One or more target locations may be located/embedded within the first 3-D image. Such target locations may be selected by, for example, a computer or a physician. This first 3-D image and its target locations may be stored to computer readable medium. In this regard, the first 3-D image may form a control volume that is utilized to identify, for example, biopsy locations. At subsequent second time, a second 3-D image (e.g., current image) is obtained for the same internal object of interest. It will be appreciated that movement between the obtaining of the first and second 3-D images may prevent direct application of the target locations from the first image to the second image. Accordingly, the present utility initially performs a rigid transformation of the first 3-D image/control volume in order to translate the first 3-D image to a substantially common frame of reference of the second 3-D image. While improving the correspondence between the 3-D images, such rigid transformation may not account for non-rigid deformation of the internal object of interest that may be caused by, for example, contact of internal object of interest with a biopsy probe. To account for such non-rigid deformation, the utility elastically transforms a portion or all of the boundary of the first 3-D image as translated into the common frame of reference to match boundaries of corresponding portions of the second 3-D image. In this regard, the target locations within the first 3-D image may be translated into the second 3-D image such that their locations are updated for the current orientation and/or deformation of the internal object of interest as represented by the current 3-D image.

Generally, targets will be spatially assigned within the first 3-D image or control volume. (V₀) at time t₀. The utility may perform a 3-D scan of the control volume V₀ via 2-D sectioning of the volume. 3-D image segmentation may be performed, either by segmenting the 2D images followed by reconstruction, or directly segmenting the 3-D image compiled from the raw 2D sections. The surface of the volume is obtained in silico via rendering. Target locations of regions (e.g., suspected lesions) may be identified within the control volume.

Following this, a method of intersecting the assigned targets (e.g., biopsy) may be planned. During such a target intersecting procedure, the imaging transducer that generated the control volume and which may include a target intersecting instrument, is used to rescan the internal object of interest while the intersecting instrument aims for the assigned targets. During this stage, the probe or other agents may cause the control volume to shift or change shape so that the second 3-D image/current volume Vₙ differs from V₀.

In one arrangement, the utility finds the difference between these volumes using a single 2D scan and its position. As the imaging operator uses the probe, a 2-D plane, which is a slice of the current volume Vₙ at current time Aₙ, is obtained in real-time. The software and/or hardware of the utility then transforms the plane from the acquisition space, i.e., world coordinates into a Cartesian model space coordinates (x, y, z). Also in real-time, the software and/or hardware performs an automated 2D image segmentation on Aₙ to obtain the boundary Bₙ. The software then uses the new x, y, z space and Bₙ to search for the corresponding plane that has the same shape and coverage as Bₙ. in the control volume. Once this plane (Bₘ) is found, a transform (T) is calculated to change the position of Bₙ to the position of Bₘ. The software then applies T to the V₀ to compute the new, updated volume location Vᵤ. This way, the old volume is rotated and translated so that it matches the current position of the object of interest as represented by the current volume Vₙ such that correct intersecting of the target(s) can be achieved.

A further objective is to find the shape change of a current 2D plane that contains a target to be intersected. After the current volume position is renewed, the operator maneuvers the probe-intersecting device toward the target. The real-time imaged plane is again automatically segmented to produce B_{c}. The software then finds the boundary of the object (e.g., prostate) in the corresponding plane (Bₘ) in Vᵤ and rapidly warps (e.g., elastically transforms) it to the current boundary B_{c}. With interpolation based on an elastic model, the targets are relocated to the current boundary shape and are displayed on an output display of Vₙ. The target intersecting device is guided toward the new target location.

Elastically transforming the 2D planes may be based on 2D to 2D boundary warping. IN one arrangement, each voxel of the control volume 2-D plane is given a value that is equal to the distance from the center of the area of the object (e.g., prostate). These values may then be used with corresponding values in the current volume 2-D plane to effect the warping. IN another arrangement, warping may be done using a radial method where the boundary as intersected by each radial emitting form the center of the 2-D plane of the control volume is adjusted to a corresponding length of a corresponding radial in the 2-D plane of the current volume. Other deformation methods may be applied as well.

### BRIEF DESCRIPTION OF FIGURES

FIG. 1 shows the operation of an end-fire transrectal ultrasound probe, its scanning area, and the fulcrum about which it pivots.

FIG. 2 shows a 3D image generated using the probe system of FIG. 1.

FIGS. 3A-C show a schematic diagram of a target translocated due to non-rigid motion of the organ (prostate) and the updating of a target aim (cross).

FIG. 4 shows a schematic diagram of capturing a 2D scan and segmenting it in real-time while the doctor maneuvers the probe-needle device.

FIG. 5 shows a schematic diagram of re-sampling the constructed 3D model according to the position and orientation of the current 2D frame acquired in FIG. 4.

FIG. 6 shows a search for the best position of the plane containing Bₙ (found in FIG. 4) located in the B₀ range (found in FIG. 5).

FIG. 7 shows the 3D rotation and translation of the prostate model using the search result found in FIG. 6.

FIG. 8 shows the 2D warping of the model section containing the target of focus to the current section imaged by the probe-needle assembly.

FIG. 9 shows a schematic of the renewed prostate position, targets within, and needle guidance.

FIG. 10 shows a schematic diagram of a repeat biopsy using the tracking system.

FIG. 11 shows an object process diagram of the overall processes involved in the invention.

FIG. 12 shows the detail processes inside the action block “Perform 3D biopsy with tracking” in FIG. 11.

FIG. 13 shows the detail processes inside the action block “Perform 3D biopsy with motion mitigation” in FIG. 12.

FIG. 14 shows the detail processes inside the action block “Correct position” in FIG. 13.

FIG. 15 shows the detail processes inside the action block “Find transform” in FIG. 14.

FIG. 16 shows the detail processes inside the action block “Rigid transformation” in FIG. 15.

FIG. 17 shows the detail processes inside the action block “Non-rigid transformation” in FIG. 15.

### DETAILED DESCRIPTION

Reference will now be made to the accompanying drawings, which assist in illustrating the various pertinent features of the various novel aspects of the present disclosure. The present invention will now be described primarily in conjunction with ultrasound imaging. Although the invention is described primarily with respect to an ultrasound imaging embodiment, the invention is applicable to a broad range of three-dimensional modalities and techniques, including MRI, CT, and PET, which are applicable to organs and/or internal body parts of humans and animals. In this regard, the following description is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. The embodiments described herein are further intended to explain known modes of practicing the invention and to enable others skilled in the art to utilize the invention in such, or other embodiments and with various modifications required by the particular application(s) or use(s) of the present invention.

Initially, an exemplary embodiment of the invention will be described that serves to provide significant clinical improvement for biopsy using transrectal ultrasound (TRUS) guidance. By this imaging technique, a prostate capsule/volume is tracked and the internal area of any slices of the volume is interpolated via an elastic model so that the locations of targets and within the volume are updated in real-time.

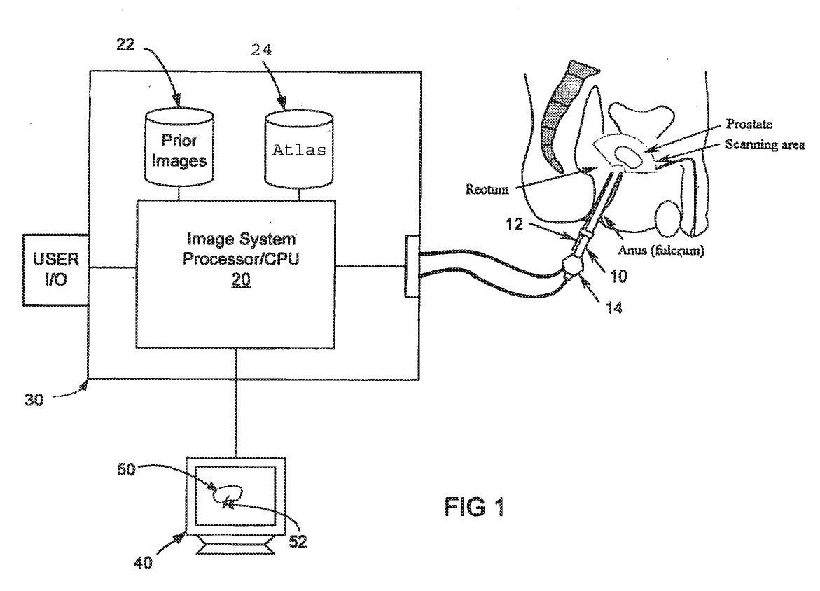

An overview of the operation with a TRUS probe and ultrasound imaging system is shown in FIG. 1. The ultrasound probe 10 has a biopsy needle assembly 12 attached to its shaft inserted into the rectum from the patient's anus. The probe 10 is an end-fire transducer that has a scanning area 6 of a fan shape emanating from the front end of the probe (shown as a dotted outline). The probe handle is held by a robotic arm (not shown) that has a set of position sensors 14. These position sensors 14 are connected to the computer 20 of the imaging system 30 via an analog to digital converter. Hence, the computer 20 has real-time information of the exact location and orientation of the probe 10 in reference to a unified Cartesian (x, y, z) coordinate system.

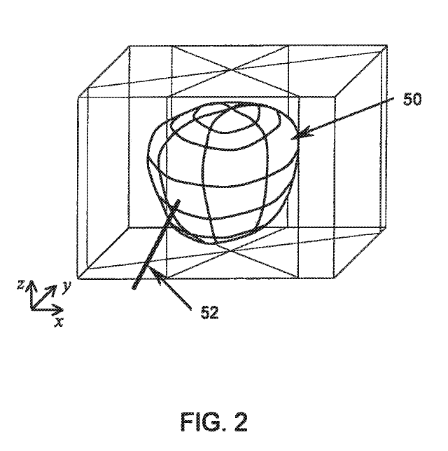

With the dimensions of the probe 10 and needle assembly 12 taken into the calculations, the 3D position of the needle tip and its orientation is exactly known. The ultrasound probe 10 sends signal to the ultrasound system 30, which is connected to the same computer (e.g., via a video image grabber) as the output of the position sensors 14. In the present embodiment, this common/same computer is integrated into the imaging system 30. The computer 20 therefore has real-time 2D images of the scanning area in memory 22 as well. The image coordinate system and the robotic arm coordinate system are unified by a transformation. Combining the above techniques, a prostate surface 50 and biopsy needle 52 are simulated and displayed on a display screen 40 with their coordinates displayed in real-time as best shown in FIG. 2. As shown, the rectangular box enclosing the 3D image 50 contains three vertical slices of the image obtained from the ultrasound probe 10 and which are reshaped from spherical coordinates to Cartesian coordinates. A first scan is performed by the probe 10 and computer system 20 to constitute a 3D pre-procedural image data set such as simulated in FIG. 2. A biopsy needle is also modeled on the display, which has a coordinate system so the doctor has the knowledge of the exact locations of the needle and the prostate.

The computer system runs application software and computer programs which can be used to control the system components, provide user interface, and provide the features of the imaging system. The software may be originally provided on computer-readable media, such as compact disks (CDs), magnetic tape, or other mass storage medium. Alternatively, the software may be downloaded from electronic links such as a host or vendor website. The software is installed onto the computer system hard drive and/or electronic memory, and is accessed and controlled by the computer's operating system. Software updates are also electronically available on mass storage media or downloadable from the host or vendor website. The software, as provided on the computer-readable media or downloaded from electronic links, represents a computer program product usable with a programmable computer processor having computer-readable program code embodied therein. The software contains one or more programming modules, subroutines, computer links, and compilations of executable code, which perform the functions of the imaging system. The user interacts with the software via keyboard, mouse, voice recognition, and other user-interface devices (e.g., user I/O devices) connected to the computer system.

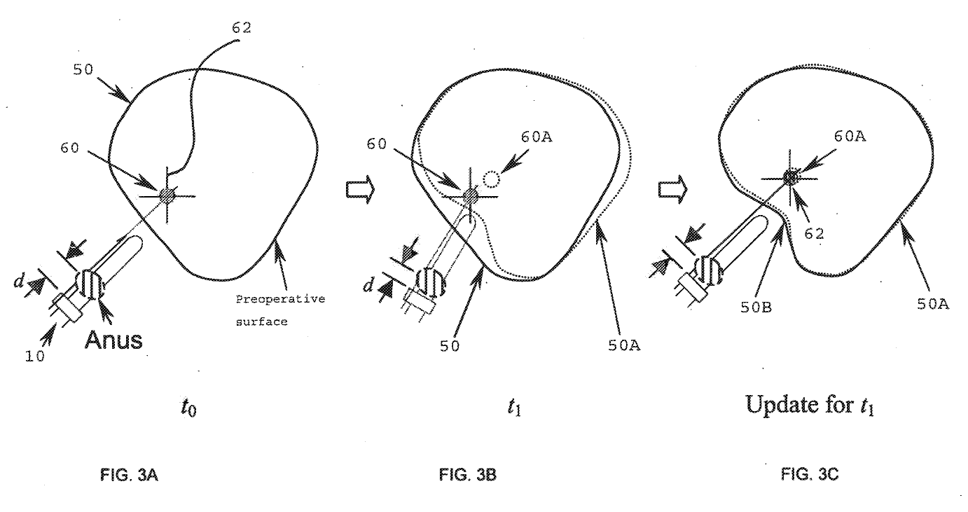

FIGS. 3A-3C illustrate a schematic diagram that demonstrates the problem and solution according to the invention. As shown in FIG. 3A, which illustrates a 3D prostate surface 50 with a 2D side view, a suspected lesion 60 is identified within the prostate (a gray dot). A target location 62 (i.e, a crosshair aim) is calculated to be located on top of the lesion 60 for guiding a biopsy needle 12 for sampling the suspected lesion 60. The TRUS probe 10 is shown on the lower-left corner of the prostate boundary with a mounted biopsy needle that is aimed to the target location to be fired at the suspected lesion 60. The dotted shape of the needle indicates the furthest position of the needle when it is fired from the needle gun. This scheme shows an ideal situation in which the prostate or patient does not move between the planning and biopsy needle firing. In such an ideal situation, the targeted region inside the boundary of the suspected lesion may be successfully sampled. In a more common situation, a planning session is initially performed using the 3D image at a first time t₀ and temporally subsequent biopsy session is performed to sample suspected lesions identified in the 3D image at a second time t₁.

Typically, due to patient movement (voluntary or involuntary) and doctor's handling of the TRUS probe inside the rectum, the prostate position at t₁ is different from what was scanned at the planning stage of the biopsy test at t₀. And because of the viscoelastic property of the prostate tissue, the shape of the prostate usually deforms as well as illustrated in FIG. 3B. As shown, the solid curve is the same shape as the prostate surface 50 at t₀. The dotted curve shows the new or defined surface 50A when the probe 10 forcefully pushes toward the prostate from the lower-left side at t₁. Note that the distance d between the needle channel mount and the anus is shortened between to t₁. Also note that the new shape at t₁ is not merely a Euclidean transform, rather the shape is deformed. Due to the elasticity of the organ, its internal matter elastically deforms as well. Therefore, the region of interest (e.g., target) that contains the suspected lesion 60 is shifted from its original position. This new region is marked by a dotted circle 60A inside the new surface. Presently, if the needle 12 is still guided to sample the original target (crosshair 62 over gray dot 60), then it will not sample the correct tissue region, i.e., the needle tip does not penetrate the dotted circle 60A. The current invention solves this problem by rapidly finding the new position of the prostate boundary and re-focusing the needle to an updated target position(s).

FIG. 3C shows the result of an updated prostate boundary found by re-scanning the prostate at t₁. The re-scanned and re-constructed new surface 50B is very close to the actual surface 50A at t₁, which is represented by a dotted curve. Within it, the dotted circle 60A representing the shifted new suspected lesion region is now very close to the corrected target, as shown by the crosshair 62 (e.g., representing renewed target coordinates) on top of the original target 60. The needle 12 is then guided to fire toward this target 60A and correctly samples a piece of tissue within the region containing the suspected lesion 60. When implemented, this strategy will allow for repeatedly scanning the prostate to check for movement and repeatedly updating the corrected target positions accordingly in real-time. This will ensure correct sampling of all lesion regions. The details of carrying out the renewed focus of needle is disclosed below.

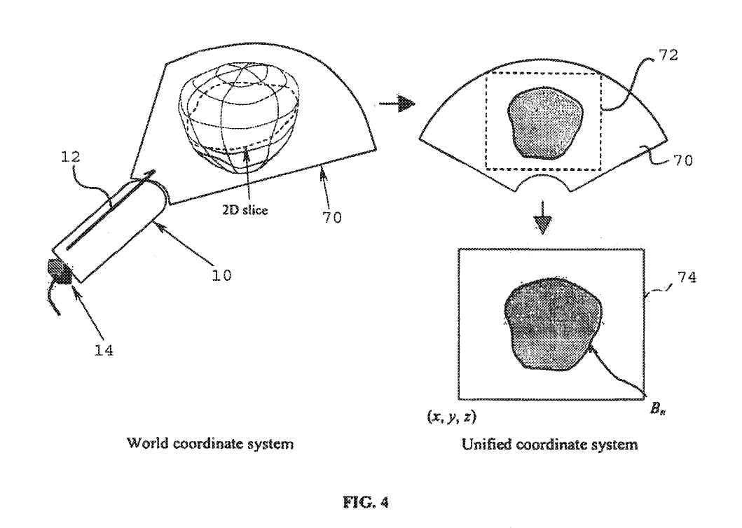

FIG. 4 shows a schematic diagram of capturing a 2D scan and segmenting it in real-time while the doctor maneuvers the probe-needle device. During the maneuver for targeting, the doctor aims for the current target and images a 2D plane or scan area/plane that contains a target. Note that the scanned plane 70 may always contain the needle 12 in the view, i.e., the needle plane and scan plane may be coplanar. In this regard, the probe-needle device 10 may have a position sensor 14 attached so that the location of the scanned image is defined according to the coordinate system. The fan-shaped image output 70 captured from the ultrasound machine is initially captured in the spherical coordinate system (r, θ, φ). The images are then converted to rectangular system (x, y, z) (i.e, cropped 72 and represented by a unified Cartesian coordinate system 74). The software performs rapid 2D segmentation to delineate the boundary of the scan. This boundary of the scan at current time n is called Bₙ. One non-limiting method for segmentation is provided in co-pending U.S. application Ser. No. 11/615,596, entitled, “OBJECT RECOGNITION SYSTEM FOR MEDICAL IMAGING,” having a filing date of Dec. 22, 2006, the content of which is incorporated by reference herein.

The position of the acquired 2D image 70 during the maneuver is known via the position sensor 14 attached to the probe 10. The computer then searches for a plane in a pre-operatively constructed 3D model that contains the same prostate information as this 2D image 70. The found plane is used to calculate a rotation and/or shift between the old model and the current prostate position.

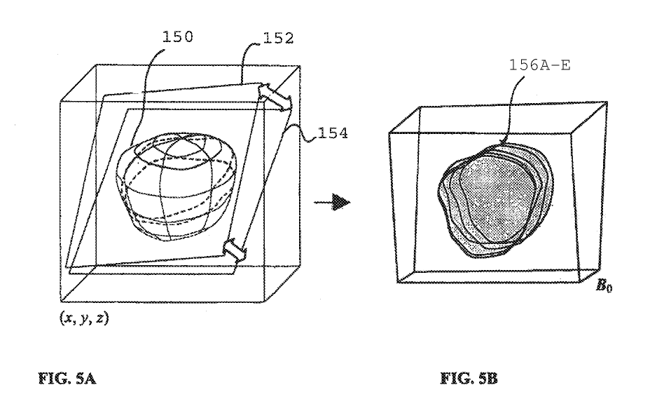

FIGS. 5A and 5B show the process of obtaining a search volume from a previous 3D model of the prostate 50. This previous or ‘old model’ 150 may be a 3D image/volume obtained and stored in a computer readable memory 22 during a previous examination (See, e.g., FIG. 1) or prior to deformation. As shown in FIG. 5A, a search volume is defined by two slices 152, 154 cutting through the old model represent the upper and lower bound of the search volume. Such a search volume may be selected by a user or may be implemented by the computer based on a comparison of the size of the current slice with corresponding regions of the prostate image. In one exemplary embodiment, five non-parallel slices/planes 156A-E are obtained in this volume with their boundaries delineated as shown in FIG. 5B. This process is very fast as it only requires interpolation of the surface voxels of the old model 150 already found before the procedure to obtain 2D pixel coordinates. FIG. 5B shows the search volume having the boundaries embedded. This set of boundaries is called boundaries at time 0, or B₀.

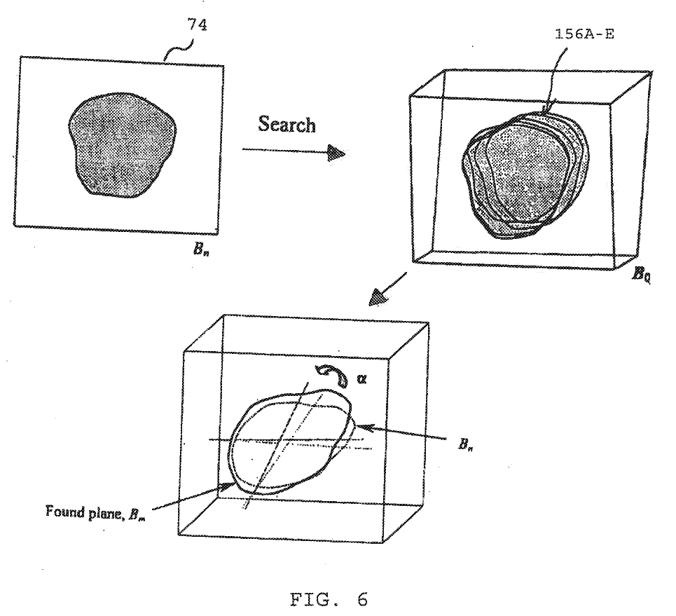

FIG. 6 illustrates the selection of the “best” plane (i.e., the plane 156A-E that best matches the current plane Bₙ) within the search volume. The search involves control points on B, and uses a method of downhill Simplex in multi-dimensions to solve an optimization problem, though other methods may be utilized. According to the position of Bₙ, the search result is shown on the bottom of FIG. 6. The box shows a 3D representation of the current image 70 or needle plane that contains B, (dotted curve) and the found plane (e.g., best matching plane) that contains boundary Bₘ (solid curve). The rotational angle and translational shift, which are collectively called the notation α, shows the parameters of the transformation from one plane to the other.

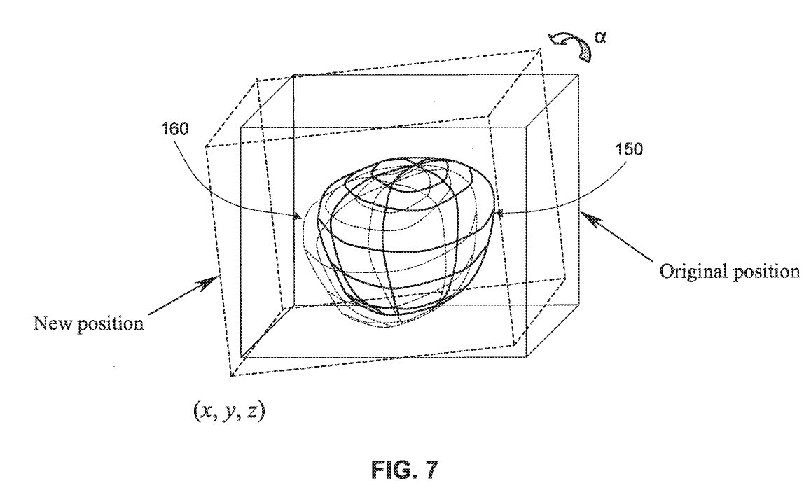

The result of this search gives the transformation needed to rotate and translate (i.e., rigidly) the pre-operatively constructed old model 150 to the current operative situation (i.e., current 3D image 50). This transformation is exemplified in FIG. 7. In it, the original position of the old model 150 is shown in solid lines enclosed by a solid line box frame. The new, current position is shown as a new model that is transformed by the parameter α. The new position is shown as dotted lines enclosed by a dashed box frame. The updated model 160 closely matches the current position of the prostate undergoing biopsies. That is, the updated model 160 closely matches the position of a current 3D image 50. See FIG. 7.

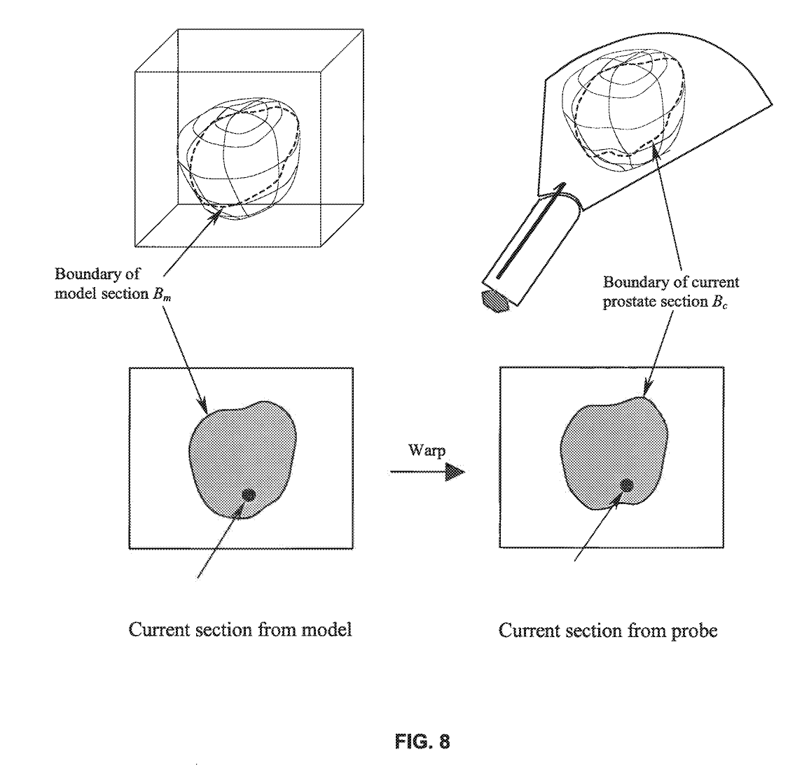

As a result of the transform, the system then uses a to direct the positioning of the probe-needle device toward the updated plane that contains a target of interest. The doctor updates the position of the probe-needle device; at this moment, a new 2D scan that contains the target of interest 60 becomes current. See FIG. 8. A rapid 2D segmentation is carried out again to delineate the boundary in this plane. Even though this plane should be the closest match to the updated model 2D section, to further increase biopsy accuracy, a 2D warping process is applied to account for any planar deformation. The process uses the two boundaries to warp the model boundary Bₘ to fit the current image boundary B_{c}. An elastic deformation technique is used to interpolate the shift of the target 60 based on the deformation of the 2D boundaries. FIG. 8 illustrates this process with an example.

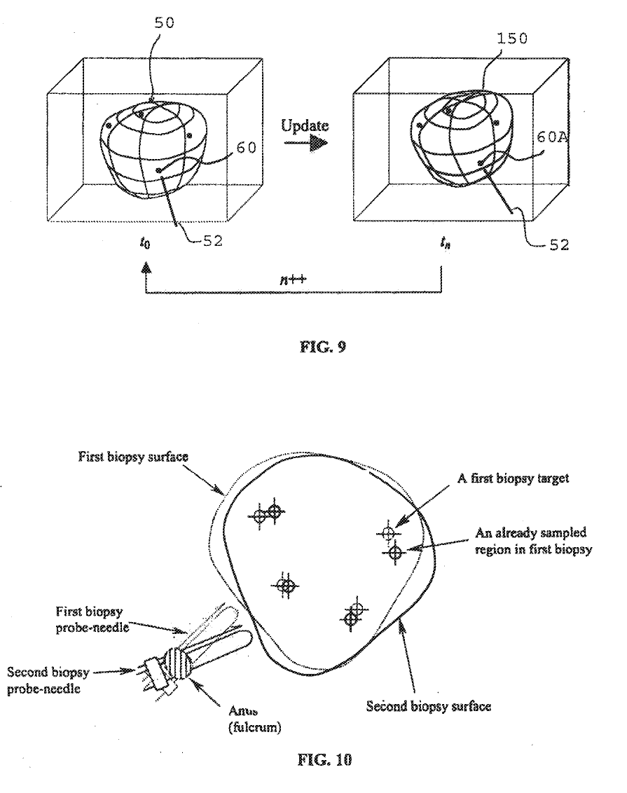

After having relocated the plane that contains the target of interest 60 and re-mapping the target location 60A within this plane by warping the model section (i.e., non-rigidly), an overall model that guides the biopsy needle is constructed and displayed on the computer screen. As shown in FIG. 9, this entire process of relocating the plane, 2D remapping the target, and re-computing needle guidance is constantly repeated (time increment n++) until all the planned targets are intersected by the biopsy needle. Because it is carried out effectively in real-time, the doctor has an continuously refreshing prostate model and biopsy guidance displayed on the computer screen as he or she moves the probe-needle device.

FIG. 10 illustrates an extension of the application of this invention. It shows a repeat biopsy case in which the shape of a prostate during a second biopsy is different from the same prostate at the first biopsy (a year earlier, for example). The diagram is a 2D side view of a 3D volume. The dotted lines represent the situation of the first biopsy whereas the solid lines represent the situation of the current, second biopsy. The targets are shifted in space according the different position of the prostate in the second biopsy. Tracking is performed the same way as the first biopsy but with additional knowledge of the already sampled regions.

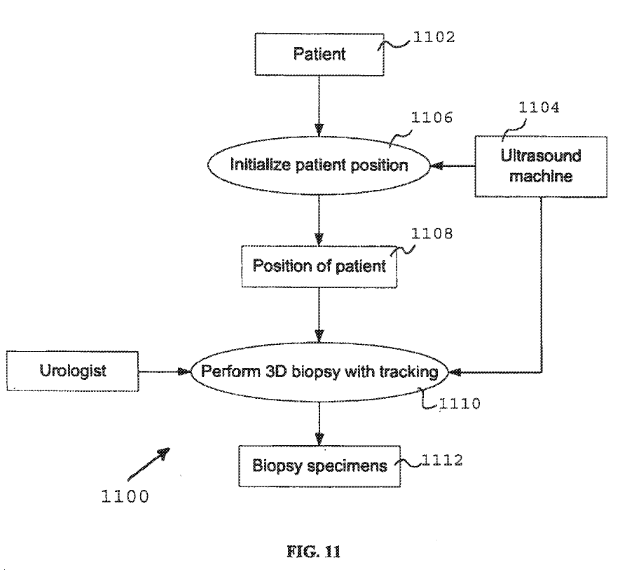

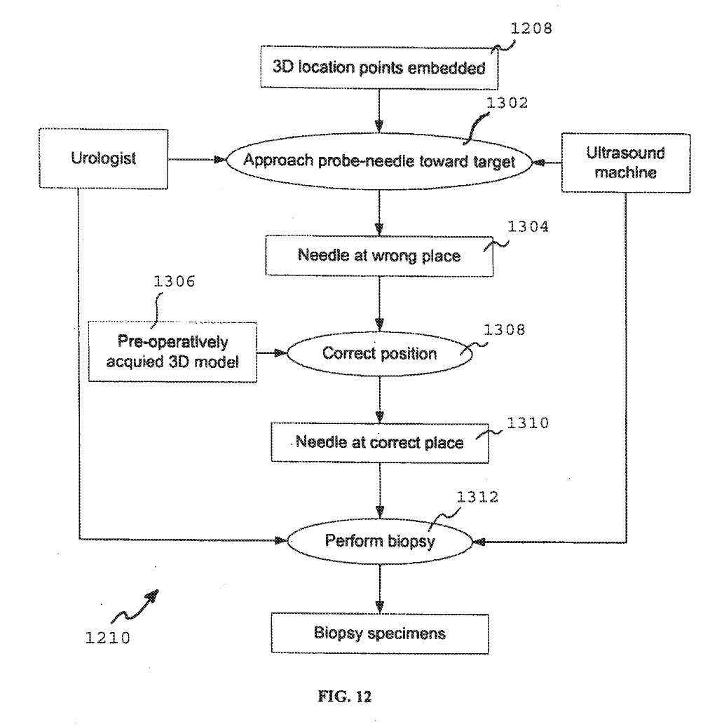

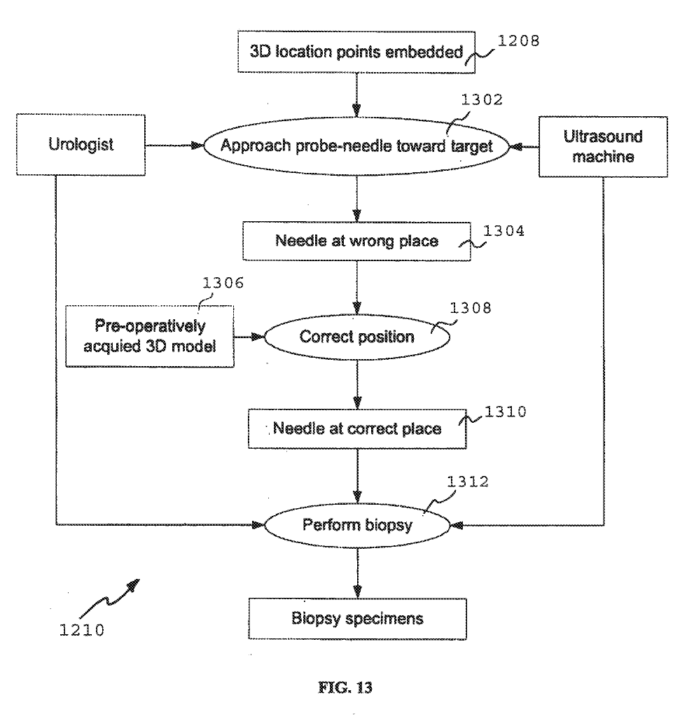

FIGS. 11-17 illustrate object process diagrams (OPD) that summarize the objects and process flow of various aspects of the presented embodiment of the invention. The overall OPD is shown in FIG. 11 while detailed sub-processes of the major processes of FIG. 11 and subsequent OPDs are shown in FIGS. 12-17. In the figures, the rectangular boxes are objects or data, while the ovals represent processes or actions. For FIGS. 12-17, each one explains in detail a process of a previous figure. It will be appreciated that these FIGS illustrate one embodiment of the invention and that variation from these OPDs is positioned and considered within the scope of the present invention.

One embodiment of the invention is shown in FIG. 11. Overall, the targeted biopsy procedure starts 1100 with a patient 1102 who is positioned on an examination bed/table that has the robotic arm connected thereto. The ultrasound machine 1104 and the ultrasound probe held by the robotic arm record 1106 the patient's initial position 1108. The doctor (urologist) then performs 3D biopsy 1110 with the tracking capability described above to obtain one or more biopsy specimens 1112.

FIG. 12 shows the details of performing 3D biopsy with tracking 1110. The urologist uses the ultrasound machine 1104 and probe to perform a first-time acquisition of the prostate 3D image 1202. This is done by sampling non-parallel 2D images. The 2D image stack is used to reconstruct to output 3D data 1204. A series of 2D segmentation is carried out to delineate the boundary of each section. The prostate sections delineated by these boundaries are then reconstructed to produce a 3D volume as a model of the prostate. The 3D data is used for planning 1206 to identify suspected lesions/plan targets. The plan may be based on a previously computed probability atlas model, which may be accessible by and/or stored 24 by the computer of the imaging system 30. See, e.g., FIG. 1. Such an atlas may describe the distribution of cancer location compiled from cancer patients. A separate algorithm may be used to maximize the chance of finding cancer by K number of biopsy needles. An imaging approach can also be used by detecting, for example, hypoechoic regions inside the prostate capsule. Alternatively, the doctor may manually select targets. Regardless the method, 3D coordinates of target points located inside the model (i.e., preoperative model) are output from the planning process 1206 and these target points are embedded within the 3D model. The model may be stored for subsequent or near immediate use. Following the target planning 1206, the urologist uses the ultrasound device to perform 3D biopsy 1210 with tracking and mitigation of prostate motion.

FIG. 13 shows the details of performing 3D biopsy with motion mitigation 1210. Following the planning in which 3D location points of desired targets are embedded 1208 in a 3D image/model (i.e., old model), the urologist starts with the first target. He or she approaches 1302 the probe-needle device toward the target. Due to prostate movements (see, e.g., FIGS. 3A-C), the needle may go to the wrong location 1304 if deformation of the prostate allows the target to move away. In real-time, the system uses a current imaged plane and the pre-operatively constructed old 3D model 1306 to correct 1308 the current target position. The urologist is then guided toward the new target position 1310 and performs the biopsy 1312.

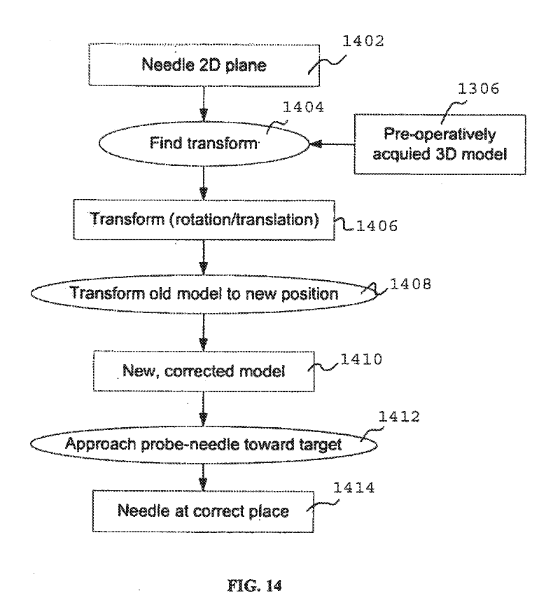

FIG. 14 describes the details of the process of correcting the target position. The computer takes the 2D image of the current needle plane 1402 and searches in the pre-operatively acquired old 3D model 1306 for a transform 1404 that can describe the movement of the prostate. The output of the search is a resultant transform 1406, which is used to rotate and/or translate 1408 the old model to the current new position defining a new model 1410. As a result of the transform, the probe-needle is guided 1412 toward the correct place 1414 for sampling the target of interest.

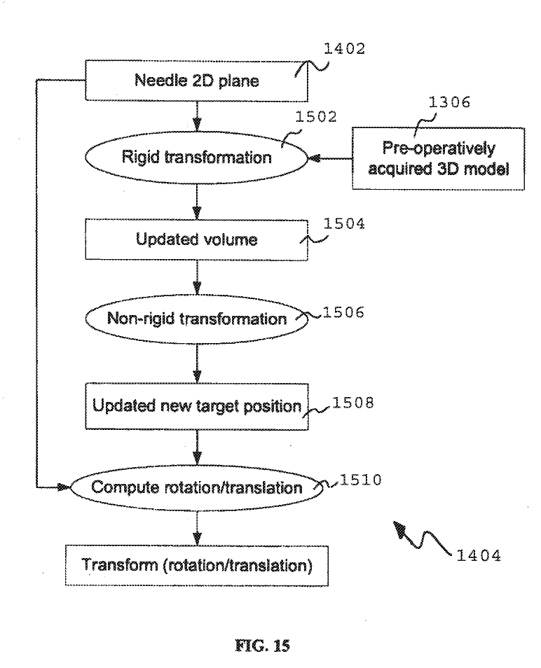

FIG. 15 shows the details of the process of calculating the transform 1404. Based on the position of the current needle 2D plane 1402, a search volume is defined within the pre-operative 3D old model 1306. The image of the current needle plane 1402 is segmented rapidly to delineate the boundary. This boundary is searched inside the defined volume for an optimal plane that best matches. The location of this found plane is then used to compute the rigid transform 1502 that does the proper rotation and/or translation. This allows for rigidly rotating the old model to a new position, i.e., new volume 1504, corresponding with the current 3D image/volume, as discussed above in relation to FIG. 7. Once the new model/updated volume is generated, a non-rigid transformation is applied 1506 to the new model to update target positions 1508. These new target positions are used 1510 with the current image plane 1402 to locate the desired target thereon.

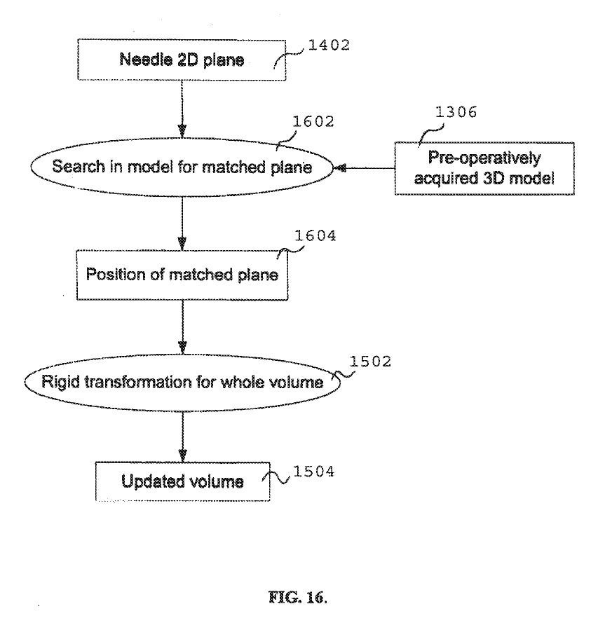

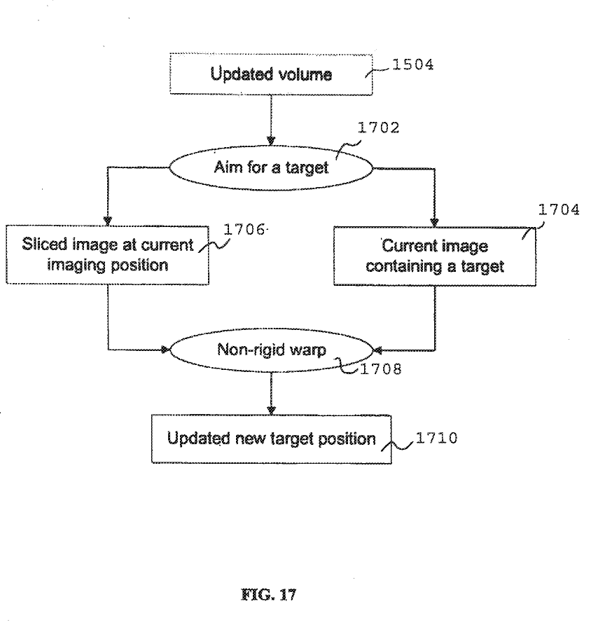

FIG. 16 explains the detail block of rigid transformation 1502. For the rigid transformation, FIG. 17 shows a search 1602 in the pre-operatively acquired 3D model for the match 1604 to current, live 2D plane. It then uses the transform 1502 to rotate/translate the pre-operatively acquired model to an updated volume 1504. Searching is an optimization problem that is defined by initial guesses for setting up the problem is obtained from the position of the current, live 2D image slice. This optimization problem has constraints to define the search volume that is shown in FIG. 5. These constraints are put so that it restrict impossible plane positions due to the restricted placement of the ultrasound probe inside the rectum. These constraints will also increase search speed.

FIG. 17 show the details of the non-rigid transformation 1506. Once the updated volume 1504 is obtained, the ultrasound probe-needle assembly is navigated toward a position for which a target 1702 is contained by the image slice. However, the current, live image slice may be of a different shape (e.g., due to tissue deformation) from what is sampled from the updated volume. Here, a non-rigid transformation is calculated based on the two segmented images. One is the live image 1704; the other is the sliced image 1706 from the updated volume. A model of elastic property (i.e., non-rigid warp 1708) is used here to interpolate where the updated, correct target position 1710 lies within this slice. The doctor is then navigated toward this updated target for sampling.

It is noted that the process of approaching probe-needle toward target may be a constant process; therefore, approaching and the process of calculating a “correct position” are run in a loop until all targets are successfully punctured by the biopsy needle(s). With this loop going, the prostate animation along with the needle animation will be refreshed on the computer screen in real-time to recreate in silico the actions taking place. With this invention, a process of constant refocusing of the needle on a moving target is provided. With these above processes, the urologist can operate the computerized ultrasound system that may include the ultrasound machine, probe-needle assembly, the robotic arm, and the computer to successfully sample the wanted areas containing potential cancer tissue.

A further embodiment of the invention may incorporate utilization of an ultrasound probe that has capability of simultaneous biplane imaging such as the Model 8808 from BK Medical (Denmark). This way, the image acquisition rate is doubled. Because there will be two images acquired that have known orthogonal planes in the same amount time (real-time), it will have information of the third dimension when navigating. This information can be used to find the position change of the prostate more accurately. Therefore, using such a probe leads to more accurate biopsy results as well as less patient discomfort.

Furthermore, this invention is not restricted to end-fire probes. It can have an embodiment of side-fire or end-fire probes so that any preferred mode of imaging may be used as dictated by the doctor, the patient, or the situation of the disease stage. The dimensions of the probe and needle and its channel bracket will be taken into account for calculation of its position and orientation. The only change in implementation is the plan of needle guidance for the way the probe-needle assembly approaches the target lesions.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A method for use in correcting image target coordinates in an image guided medial application, comprising:
obtaining a first 3-D prostate image at a first time, the first 3-D prostate image having at least one target location therein;
obtaining a second 3-D prostate image at a second time, wherein said first and second 3-D prostate images are models of a common prostate;
performing a rigid transformation to rotate and translate the first 3-D prostate image to a substantially common frame of reference as the second 3-D prostate image;
selecting corresponding first and second 2-D image slices from said first and second 3-D images, respectively, as aligned in said substantially common frame of reference, wherein the first 2-D image slice includes at least one target location; and
elastically transforming a first boundary of the first 2-D image slice to match a second boundary of the second 2-D image slice, wherein the at least one target location in said first 2-D image slice is translated onto the second 2-D image slice to define an updated target location in said second 3-D prostate image.

2. The method of claim 1, further comprising:
generating a display output of said second 3-D prostate image including said updated target location, wherein said updated target location may be utilized for guiding a biopsy needle to a location in the prostate.

3. The method of claim 1, wherein performing a rigid transformation further comprises:
obtaining a current 2-D image slice from said second image;
matching said current 2-D image slice to a best match plane in a search volume of said first 3-D image; and
computing a transform that describes the spatial movement from the best match plane to the current 2-D image slice.

4. The method of claim 3, further comprising:
using said transform to rigidly rotate said first 3-D image.

5. The method of claim 3, further comprising:
segmenting said current 2-D image slice to identify a boundary; and
segmenting a plurality of 2-D image slices from said first 3-D image to identify boundaries thereof.

6. The method of claim 1, further comprising:
segmenting said corresponding first and second 2-D image slices to generate said boundaries.

7. The method of claim 6, wherein elastically transforming comprises:
warping the segmented boundary of the first 2-D image slice and first area enclosed by the first boundary to fit the segmented boundary of the second 2-D image slice and second area enclosed but the second boundary.

8. The method of claim 6, further comprising:
interpolating the updated target location within the second 2-D image slice based on the boundary shape change of the first boundary.

9. The method of claim 1, further comprising:
displaying said updated target location on a display image of said second 3-D image.

10. The method of claim 1, wherein a plurality of target locations having different 3-D locations in said first 3-D image are updated into said second 3-D image.

11. The method of claim 1, wherein obtaining said images comprises obtaining ultrasound images.

12. The method of claim 1, wherein performing the rigid transformation further comprises employing a rigid transformation algorithm.

13. The method of claim 1, wherein elastically transforming further comprises employing an elastic transformation algorithm.

14. A method for use in correcting image target coordinates in an image guided medial application, comprising:
receiving first 3-D image information of an internal object of interest, wherein said first 3-D image information includes a target location within the boundary of the first 3-D image;
receiving second 3-D image information of the internal object of interest;
translating the first 3-D image into a substantially common frame of reference with the second 3-D image; and
after translating, elastically deforming at least a portion of a first boundary of the first 3-D image to match a corresponding second boundary of the second 3-D image, wherein the at least one target location in said first 3-D image is translated into the second 3-D image.

15. The method of claim 14, wherein elastically deforming comprises:
selecting a first image plane in said first 3-D image, wherein the first image plane includes said target location; and
selecting a corresponding second image plane in the second 3-D image; and
warping a boundary of the first image plane to match a boundary of the second image plane.

16. The method of claim 15, wherein a position of said target location in said second plane is interpolated based on a transform used to warp said boundary of said first image.

17. A computerized method for correcting image target coordinates during an image guided medial application, comprising:
receiving into computer memory first 3-D image of an internal object of interest, wherein said first 3-D image information includes a target location within the boundary of the first 3-D image;
receiving into computer memory a second 3-D image information of the internal object of interest;
applying a rigid translation algorithm to the translate the first 3-D image into a substantially common frame of reference with the second 3-D image; and
applying an elastic transformation algorithm for elastically deforming at least a portion of a first boundary of the first 3-D image to match a corresponding second boundary of the second 3-D image, wherein the at least one target location in said first 3-D image is translated into the second 3-D image.

18. The method of claim 17, wherein receiving 3-D image information comprises receiving ultrasound image information.
